(19) United States
(12) Patent Application Publication
(10) Pub. No.: US 2025/0224914 A1
(43) Pub. Date: Jul. 10, 2025

(54) ENVIRONMENT SCENE RECOGNITION AND DECISION-MAKING SYSTEM AND METHOD BASED ON SMART DEVICE

(71) Applicant: AAC Technologies (Nanjing) Co., Ltd., Nanjing City (CN)

(72) Inventors: Yangzhen Chen, Nanjing (CN); Lijian Ye, Nanjing (CN); Hongxing Wang, Nanjing (CN); Yuheng Jiang, Nanjing (CN); Huan Ge, Nanjing (CN); Tianjian Ni, Nanjing (CN)

(21) Appl. No.: 18/801,682

(22) Filed: Aug. 12, 2024

Related U.S. Application Data
(63) Continuation of application No. PCT/CN2024/071382, filed on Jan. 9, 2024.

(51) Int. Cl. G06F 3/16; G06V 10/70; G06V 20/50

(52) U.S. Cl. CPC G06F 3/165; G06V 10/87; G06V 20/50

(57) ABSTRACT

Provided is an environment scene recognition and decision-making system and method based on a smart device. The system includes: an acquisition module disposed in the smart device to acquire environment data; a data processing module connected to the acquisition module to process the environment data to obtain environment scene features; an environment scene recognition module connected to the data processing module to recognize the environment scene features to obtain corresponding environment scenes; and a decision-making module connected to the environment scene recognition module to call a preset configuration strategy according to the environment scenes to automatically adjust audio configuration parameters of the smart device. Through the above methods, different environment scene may be recognized and the corresponding audio configuration parameters of the smart device may be adapted in different environment scenes, which may effectively improve the user experience.

### TECHNICAL FIELD

The present disclosure relates to the technical field of smart device and, in particular, to an environment scene recognition and decision-making system and method based on smart device.

### BACKGROUND

Smart devices such as smart phones, smart earphones, augmented reality (AR)/virtual reality (VR) devices are more and more widely used in people's daily work and life, users have higher requirements on the functionality of the smart devices. The smart devices are expected to compensate for effect loss caused by different environment scene features. In general usage scenes, for example, in a noisy environment, timbre of the mobile phone's amplifier is adjusted, and definition of audio play is improved by increasing the medium-high frequency. For example, when a person talks with a user, a smart earphone is changed from a noise reduction mode to a voice transparent mode. In different use scenes, default parameters or configurations of the smart device are no longer suitable, manual adjustment of the user is required, the smart device does not have dynamic adjustment capability based on environment scenes, and thus the user experience is poor.

### SUMMARY

The present disclosure provides an environment scene recognition and decision-making system and method based on a smart device, which can recognize different environment scenes and adapt audio configuration parameters of corresponding smart devices in different environment scenes, which may effectively improve user experience.

In order to solve the above technical problem, a technical solution adopted by the present disclosure is to provide an environment scene recognition and decision-making system based on a smart device, including: an acquisition module disposed in the smart device and configured to acquire environment data; a data processing module connected to the acquisition module and configured to process the environment data to obtain environment scene features; an environment scene recognition module connected to the data processing module and configured to recognize the environment scene features to obtain corresponding environment scenes; and a decision-making module connected to the environment scene recognition module and configured to call a preset configuration strategy according to the environment scene to automatically adjust audio configuration parameters of the smart device.

As an improvement, the environment scene recognition module includes a finite state machine model or a classification network model.

As an improvement, when the environment scene recognition module is the finite state machine model, the data processing module includes: one or more of a human voice detection unit, a quiet/noisy detection unit, a long-term noise detection unit, an outdoor/indoor detection unit, a traffic mode detection unit, and a motion/static detection unit, and the environment scene features are environment scene types corresponding to the output of each detection unit.

As an improvement, when the environment scene recognition module is the classification network model, the data processing module includes: a feature extraction unit or a feature extraction network, and the environment scene features are features configured to recognize the environment scene types.

As an improvement, the environment scene feature includes one or more of a human voice feature, a noise pressure level, a noise frequency spectrum feature, a resultant acceleration feature, an angular acceleration feature, and a carrier to noise ratio (CNR) of a visible satellite.

As an improvement, the acquisition module includes one or more of an accelerometer, a gyroscope, a magnetometer, a global positioning system (GPS)/global navigation satellite system (GNSS) receiver, a light sensor, a proximity sensor, and a microphone.

As an improvement, the environment scene includes a quiet indoor scene, a quiet outdoor scene, a long-term continuous noise scene, a quiet indoor human speaking scene, an outdoor sports scene, a public transportation vehicle scene, a noisy outdoor scene, and a noisy indoor scene.

As an improvement, the configuration strategy includes a first audio configuration strategy corresponding to the quiet indoor scene, a second audio configuration strategy corresponding to the quiet outdoor scene, a third audio configuration strategy corresponding to the long-time continuous noise scene, a fourth audio configuration strategy corresponding to the quiet indoor human speaking scene, a fifth audio configuration strategy corresponding to the outdoor sports scene, a sixth audio configuration strategy corresponding to the public transportation vehicle scene, a seventh audio configuration strategy corresponding to the noisy outdoor scene, and an eighth audio configuration strategy corresponding to the noisy indoor scene. The first audio configuration strategy is medium media playing volume and balanced timbre; the second audio configuration strategy is medium media playing volume and increased low frequency sound effect; the third audio configuration strategy is increased media playing volume, reduced low frequency and increased medium-high frequency sound effect; the fourth audio configuration strategy is reduced media playing volume; the fifth audio configuration strategy is increased low frequency Bluetooth playing; the sixth audio configuration strategy is reduced media playing volume; the seventh audio configuration strategy is increased media playing volume and reduced low frequency sound effect; and the eighth audio configuration strategy is increased media playing volume and reduced low frequency sound effect.

As an improvement, the audio configuration parameters include volume and/or sound effect.

To solve the above technical problem, another technical solution adopted by the present disclosure is to provide an environment scene recognition and decision-making method based on a smart device, applied to the environment scene recognition and decision-making system described as above, the environment scene recognition and decision-making method including: acquiring environment data based on an acquisition module in the smart device; processing the environment data to obtain environment scene features; recognizing the environment scene features by using a finite state machine model or a classification network model to obtain corresponding environment scenes; and calling a preset configuration strategy according to the environment scene to automatically adjust audio configuration parameters of the smart device.

The present disclosure has the following beneficial effects: an environment scene recognition and decision-making method based on a smart device, including: an acquisition module disposed in the smart device to acquire environment data; a data processing module connected to the acquisition module to process the environment data to obtain environment scene features; an environment scene recognition module connected to the data processing module to recognize the environment scene features to obtain a corresponding environment scene; and a decision-making module connected to the environment scene recognition module to call a preset configuration strategy according to the environment scene to automatically adjust audio configuration parameters of the smart devices. The present disclosure may recognize different environment scenes and adapt the corresponding audio configuration parameters of the smart device in different environment scenes, which may effectively improve the user experience.

### BRIEF DESCRIPTION OF DRAWINGS

FIG. 1 is a structural schematic diagram of an environment scene recognition and decision-making system based on a smart device according to an embodiment of the present disclosure;

FIG. 2 is a structural schematic diagram of an environment scene recognition and decision-making system based on a smart device according to another embodiment of the present disclosure;

FIG. 3 is a schematic diagram of states and transition conditions of a finite state machine model according to an embodiment of the present disclosure;

FIG. 4 is a schematic structural diagram of a neural network model according to an embodiment of the present disclosure;

FIG. 5 is a structural schematic diagram of an environment scene recognition and decision-making system based on a smart device according to still another embodiment of the present disclosure;

FIG. 6 is a structural schematic diagram of an environment scene recognition and decision-making system based on a smart device according to yet still another embodiment of the present disclosure; and

FIG. 7 is a schematic flowchart of an environment scene recognition and decision-making method based on a smart device according to an embodiment of the present disclosure.

### DESCRIPTION OF EMBODIMENTS

Technical solutions in embodiments of the present disclosure will be described clearly and completely below in connection with the drawings in the present disclosure, and it will be apparent that the embodiments described here are only a part of the embodiments of the present disclosure, but not all of them. All other embodiments acquired by those skilled in the art without creative efforts based on the embodiments of the present disclosure shall fall within the protection scope of the present disclosure.

The terms “first”, “second” and “third” in the present disclosure are merely used for the purpose of description, rather than indicating or implying the relative importance or the number of technical features. Therefore, features defined by “first”, “second”, “third” may explicitly or implicitly include at least one of the features. In the description of the present disclosure, “a plurality of” means at least two, for example, two, three, etc., unless specifically defined otherwise. All directional indications (such as upper, lower, left, right, front, back, etc.) in the embodiments of the present disclosure are only used to explain the relative positional relationship, motion condition, etc. between components in a specific posture (as shown in the drawings). If the specific posture changes, the directional indication may change accordingly. Furthermore, the terms “including” and “having” and any variations thereof are intended to cover non-exclusive incorporation. For example, a process, a method, a system, a product, or a device containing a series of steps or units may not be limited to the listed steps or units, but also may optionally include steps or units which are not listed, or also optionally include other steps or units inherent to the process, the method, the product, or the device.

Reference to “embodiment(s)” herein may indicate that a particular feature, a structure, or a characteristic described in connection with the embodiment may be included in at least one embodiment of the present disclosure. The appearances of such phrase in various places in the specification may not be necessarily all referring to a same embodiment or indicating an independent or alternative embodiment that are mutually exclusive with other embodiments. It is explicitly and implicitly understood by those skilled in the art that the embodiments described herein may be combined with other embodiments.

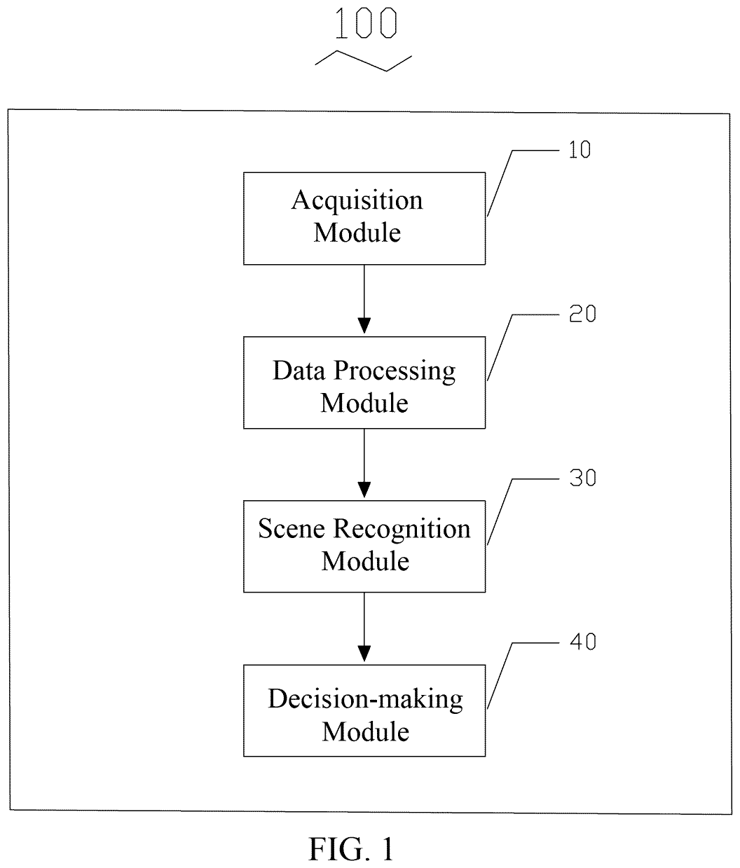

FIG. 1 is a structural schematic diagram of an environment scene recognition and decision-making system based on a smart device according to an embodiment of the present disclosure. As shown in FIG. 1, the environment scene recognition and decision-making system 100 includes: an acquisition module 10, a data processing module 20, an environment scene recognition module 30, and a decision-making module 40. The data processing module 20 is connected to the acquisition module 10, the environment scene recognition module 30 is connected to the data processing module 20, and the decision-making module 40 is connected to the environment scene recognition module 30. The acquisition module 10 is disposed in the smart device to acquire environment data, and the acquisition module 10 may include one or more of an accelerometer, a gyroscope, a magnetometer, a global position system (GPS)/global navigation satellite system (GNSS) receiver, a light sensor, a proximity sensor, and a microphone. The data processing module 20 is configured to process the environment data to obtain environment scene features. The environment scene recognition module 30 is configured to recognize the environment scene features to obtain corresponding environment scenes. The decision-making module 40 to call a preset configuration strategy according to the environment scene to automatically adjust audio configuration parameters of the smart device. The environment scene recognition and decision-making system 100 may recognize different environment scenes and adapt audio configuration parameters of corresponding smart devices in the different environment scenes, which may effectively improve user experience.

In an embodiment, the smart device includes, but is not limited to, a smart phone, a smart earphone, etc. The audio configuration parameters include volume and/or sound effects. As an example, the audio configuration parameters include volume. As an example, the audio configuration parameters include sound effects. As an example, the audio configuration parameters include both volume and sound effects.

In an embodiment, the environment scene recognition module 30 includes a finite state machine model 31 or a classification network model 32. The finite state machine model 31 may solve the problem of transitions between a finite number of states associated with each other. The classification network model 32 may be one or a combination of a feedforward neural network, a convolutional neural network, or a recurrent neural network, and the classification network may also include other machine learning algorithms.

In an embodiment, the environment scenes include a quiet indoor scene, a quiet outdoor scene, a long-term continuous noise scene, a quiet indoor human speaking scene, an outdoor sports scene, a public transportation vehicle scene, a noisy outdoor scene, and a noisy indoor scene.

In an embodiment, the configuration strategy includes a first audio configuration strategy corresponding to the quiet indoor scene, a second audio configuration strategy corresponding to the quiet outdoor scene, a third audio configuration strategy corresponding to the long-time continuous noise scene, a fourth audio configuration strategy corresponding to the quiet indoor human speaking scene, a fifth audio configuration strategy corresponding to the outdoor sports scene, a sixth audio configuration strategy corresponding to the public transportation vehicle scene, a seventh audio configuration strategy corresponding to the noisy outdoor scene, and an eighth audio configuration strategy corresponding to the noisy indoor scene;

The first audio configuration strategy is medium media playing volume and balanced timbre.

The second audio configuration strategy is medium media playing volume and increased low frequency sound effect.

The third audio configuration strategy is increased media playing volume, reduced low frequency and increased medium-high frequency sound effect.

The fourth audio configuration strategy is reduced media playing volume.

The fifth audio configuration strategy is increased low frequency Bluetooth playing.

The sixth audio configuration strategy is reduced media playing volume.

The seventh audio configuration strategy is increased media playing volume and reduced low frequency sound effect.

The eighth audio configuration strategy is increased media playing volume and reduced low frequency sound effect.

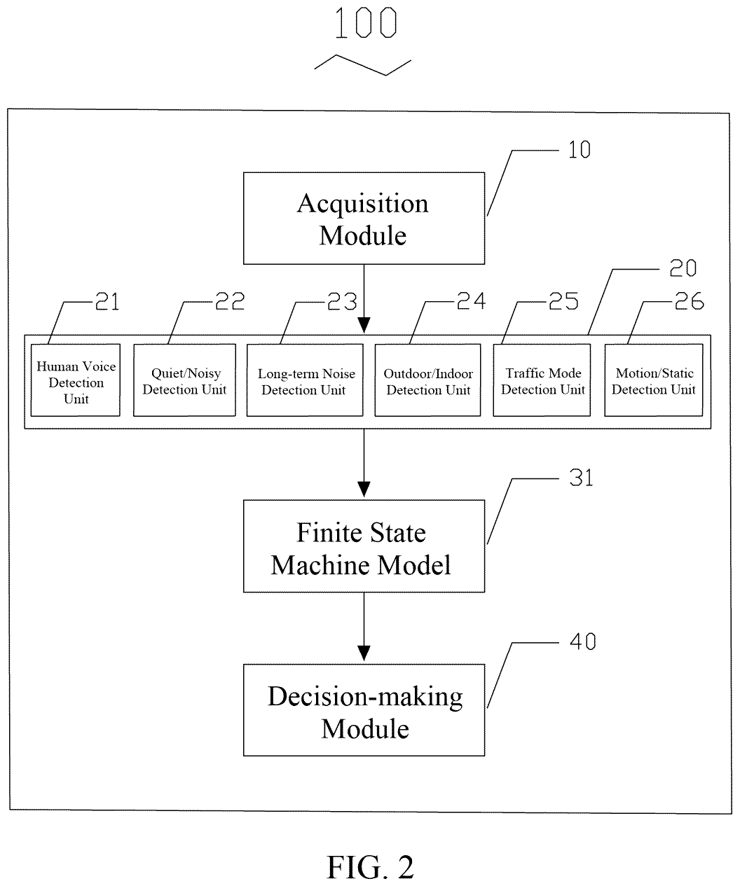

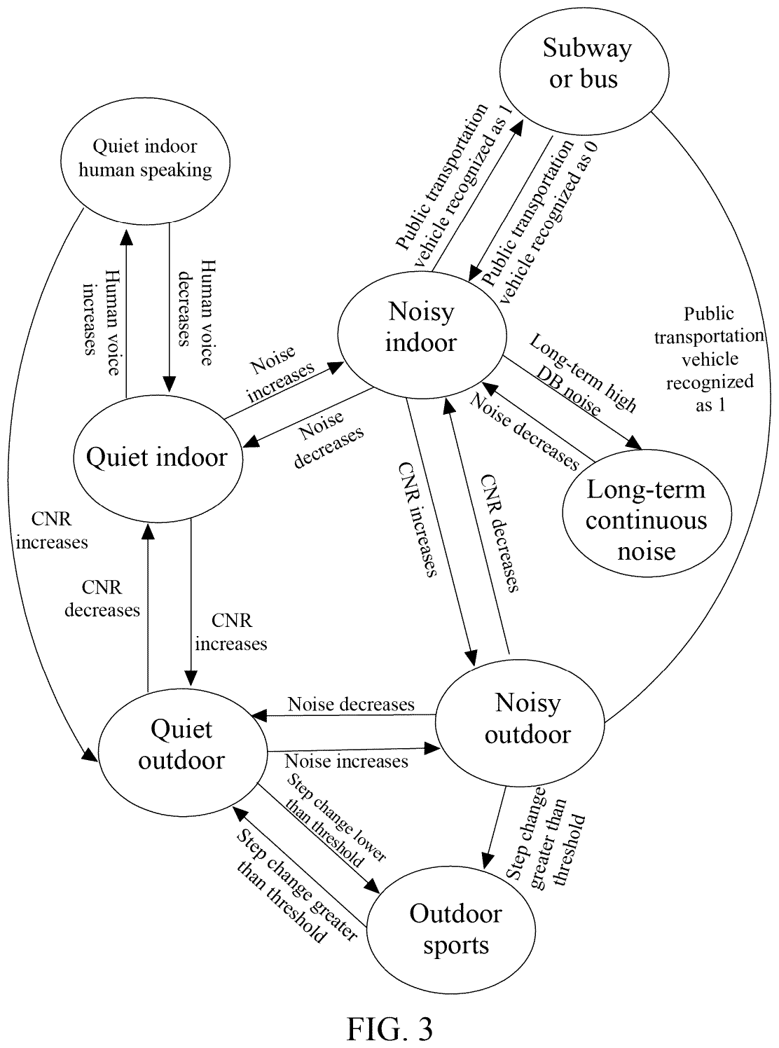

In an embodiment, referring to FIG. 2, when the environment scene recognition module 30 is the finite state machine model 31, the data processing module 20 includes: one or more of a human voice detection unit 21, a quiet/noisy detection unit 22, a long-term noise detection unit 23, an outdoor/indoor detection unit 24, a traffic mode detection unit 25, and a motion/static detection unit 26. The environment scene features are environment scene types corresponding to the output of each detection unit. For example, the environment scene types include a quiet indoor scene, a quiet outdoor scene, a long-term continuous noise scene, a quiet indoor human speaking scene, an outdoor sports scene, a public transportation vehicle scene, a noisy outdoor scene, and a noisy indoor scene. The finite state machine model 31 switches the type of the environment scene through the transition condition, as shown in FIG. 3, the initial state is a quiet indoor scene, and when it is detected that an outdoor carrier to noise ratio carrier-noise ratio (CNR) increases, it is switched to a quiet outdoor scene; when it is detected that noise increases, it is switched to a noisy indoor scene; when it is detected that human voice increases, it is switched to a quiet indoor human speaking scene. In this embodiment, the acquisition module 10 acquires environment data, each detection unit processes the environment data to obtain an environment scene type, the finite state machine model 31 switches the environment scene type through a transition condition and outputs a final environment scene, and the decision-making module 40 calls a preset configuration strategy according to the environment scene to automatically adjust an audio configuration parameter of the smart device.

In an embodiment, in the quiet/noisy detection unit 22, firstly, framing processing is performed on the audio signal acquired by the microphone; then, each frame of audio signal is multiplied by a preset gain value, then an A weighted equivalent continuous sound pressure level ((LAeq, T), referred to as Leq) of each frame of audio signal processed in the previous step is calculated, and finally, the Leq is smoothed to eliminate the jump to obtain Leq_smooth. The smoothing method may be moving average or low-pass filtering. Leq_smooth is compared with a first preset threshold, if Leq_smooth is greater than the first preset threshold, a detection result Res_noise=1 (representing a noisy environment) is output, otherwise a detection result Res_noise=0 (representing a quiet environment) is output. The first preset threshold may be adjusted according to an actual application scene, for example, the first preset threshold is 60. Finally, the sound pressure level calculated by the quiet/noisy detection unit needs to be calibrated with the audio calibration system, and during calibration, the sound pressure level output by the quiet/noisy detection unit is consistent with the sound pressure level of the calibration system by adjusting the preset gain value.

In an embodiment, in the long-time noise detection unit 23, the Res_noise value in the quiet/noisy detection unit is cached at the end of the longterm_buffer, the length of the longterm_buffer corresponds to the duration of the noise. The longterm_buffer is defined as long-time noise when the intensity of the noise exceeds a threshold and lasts for a period of time. In this embodiment, the number of “1” in the longterm_buffer is counted, that is, the length of the longterm_buffer, and when the number of “1” in the buffer reaches a second preset threshold, the detection result Res_long_term_noise=1 (representing long-term noise) is output. Otherwise, the detection result Res_long_term_noise=0 (representing non-long-term noise) is output. In this embodiment, the second preset threshold may be adjusted according to an actual application scene.

In an embodiment, in the human voice detection unit 21, whether a human voice exists is detected from the audio signal acquired by the microphone. Generally, the human voice segment and the non-human voice segment appear alternately, and if the human voice is detected and the time interval for the next occurrence of the human voice is less than the third preset threshold, it is also considered that the audio signal in this time period is the human voice. For example, in a music amplifier scene, an echo cancellation algorithm needs to be used to cancel an audio signal played by a speaker, and a noise suppression module is used to perform noise reduction to obtain pure human voice. Whether there is a human voice is detected by the human voice detection unit and the stored human voice detection algorithm. The silence segment is embedded in the human voice segment, and the detection result is continuously output instead of giving an endpoint of the human voice: whether someone is currently talking. For example, a feature extraction processing is performed on the audio signal acquired by the microphone, whether there is a human voice currently according to the feature extraction result is determined, and if there is a human voice, an intermediate result noise_count=0 is output, otherwise noise_count=noise_count+1 is output. The noise_count is compared with a fourth preset threshold, and if the noise_count is less than the fourth preset threshold, the intermediate result Res_voice_meddle=1 (human voice) is output to the voice_buffer. Otherwise, the intermediate result Res_voice_meddle=0 (unmanned voice) is output to the voice_buffer. It is counted whether the number of 1 in the voice_buffer is greater than a fifth preset threshold, if the number is greater than the fifth preset threshold, the detection result Res_voice=1 (human voice) is output. Otherwise, the detection result Res_voice=0 (unmanned voice) is output.

In an embodiment, in the outdoor/indoor detection unit 24, one method is to perform detection by using a combined set of sensors, such as an accelerometer, a gyroscope, and a magnetometer. Another method is to perform detection by using GNSS data. GNSS data refers to CNR data of all visible satellites of the same satellite navigation system such as GPS constellation. Because the GPS signal may be blocked by the building, the signal will be weakened, and the signal-to-noise ratio will be reduced, so that the outdoor signal strength is higher than that of the indoor signal. The CNR data may characterize the signal strength received by the smart device from a visible satellite. In one scene, there may be multiple visible satellites at the same time, so the CNR data is a multi-value array. In this embodiment, when CNR data is used for detection, arrays of each piece of CNR data are sorted in descending order, first N maximum values are selected to form a feature vector, and if the number of visible satellites at one moment is less than N, zero is added behind the feature vector, to ensure that the length of the feature vector is fixed to N. In an embodiment, after a large amount of CNR data of the indoor/outdoor scene is acquired, machine learning or a deep learning algorithm may be used for indoor/outdoor scene recognition. The labeled CNR data is used as a training set, a model or mapping capable of distinguishing indoor/outdoor scenes is learned, and the learned model is used for indoor/outdoor scene detection. In another embodiment, the average value or median of the N-dimensional CNR feature vectors is calculated and compared with a sixth preset threshold, if the calculation result is greater than the sixth preset threshold, the detection result Res_outdoor=1 (outdoor) is output. Otherwise, the detection result Res_outdoor=0 (indoor) is output.

In an embodiment, in the motion/static detection unit 26, when it is detected that the user carries a smart device such as a smart phone when walking/running, it is considered as a motion state (category=1). When the motion stops, it is considered as a static state (category=0). A platform such as Android provides a software program that implements a step counting function, and may be used to detect a step change of the user. If the step change in a period of time is greater than a seventh preset threshold, it is determined as a motion state, otherwise, it is determined as a static state. The bottom layer of the step counting function realized by the software program uses sensors such as an accelerometer/gyroscope of a smart phone, and the gait is detected through a signal processing or mode recognition method, so that step counting is implemented.

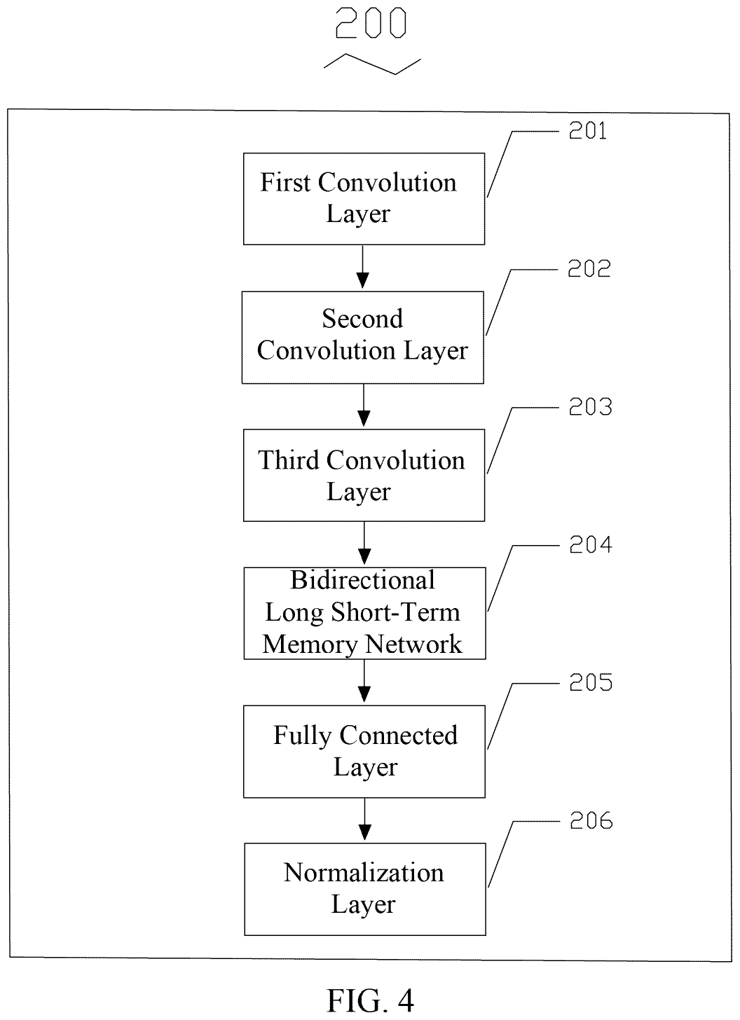

In an embodiment, in the traffic mode detection unit 25, the public transportation refers to such as a subway or a bus, and non-public transportation includes walking, stay, running, cars, etc. According to this embodiment, 3-axis data of an accelerometer of a smart phone is used, feature representation is learned from original 3-axis data through a deep learning end-to-end method, and time dynamics of acceleration time sequence data are modeled, so that various vehicles are correctly recognized. Compared with an existing detection method, the input feature of this embodiment is original 3-axis acceleration data, and the acceleration data does not need to be preprocessed, for example, removing gravitational acceleration, smoothing, and solving a root mean square value (amplitude) of the 3-axis acceleration, which simplifies the data processing process, and thus improving processing efficiency. The specific detection process is as follows: First: the acceleration data is acquired and stored, and the data is labeled. The acceleration data includes acceleration data of a subway, a bus, a car, walking, running, a bicycle, and different holding manners that are acquired by different subjected people in different time periods by using different mobile phones. The acceleration data sampling frequency is 50 Hz. Second: the neural network model is built, as shown in FIG. 4, the input of the neural network model is 3-axis acceleration data, and the output is a category label. The structure of the neural network model includes a first convolutional layer, a second convolutional layer, a third convolutional layer, a bidirectional long short-term memory network, a fully connected layer and a normalization layer which are sequentially connected to each other. The first convolutional layer, the second convolutional layer and the third convolutional layer are used for automatically extracting features of acceleration data, and the first convolutional layer and the second convolutional layer both include a 2D convolutional neural network, a ReLU activation function, batch normalization and max pooling. The bidirectional long short-term memory network is a double-layer structure and is used for modeling time dynamic characteristics. When public transportation recognition is performed, subways and buses are classified into one type (the label is 1), and other data are classified into another type (the label is 0). Third: the model is trained, the initial learning rate is 0.001, an Adam algorithm is used as the optimization algorithm, the batch size is 50, overfitting is prevented through a regularization method, the generalization ability is improved, L2 regularization is adopted by the regularization method, the size is 0.001, the ReLu activation function is used by the activation function of the convolution layer, the learning adjustment strategy of segment constant attenuation is used, and each segment of learning rate is adjusted to the original 0.9. When the training set is established, the data set is properly cut, redundant data is reduced, the diversity of the data is improved, and the model prediction accuracy may reach 90%.

In an embodiment, when the environment scene recognition module 30 is the classification network model 32, the data processing module 20 includes: a feature extraction unit 27 or a feature extraction network 28, and the environment scene features are features used to recognize the environment scene types. The environment scene feature includes one or more of a human voice feature, a noise pressure level, a noise frequency spectrum feature, a resultant acceleration feature, an angular acceleration feature, and a carrier to noise ratio of a visible satellite. In this embodiment, the environment scene features output by the data processing module 20 are used as the input of the classification network model 32. The output of the classification network model 32 is an environment scene, and then the decision-making module 40 adjusts the sound effect parameters and the volume according to the scene types.

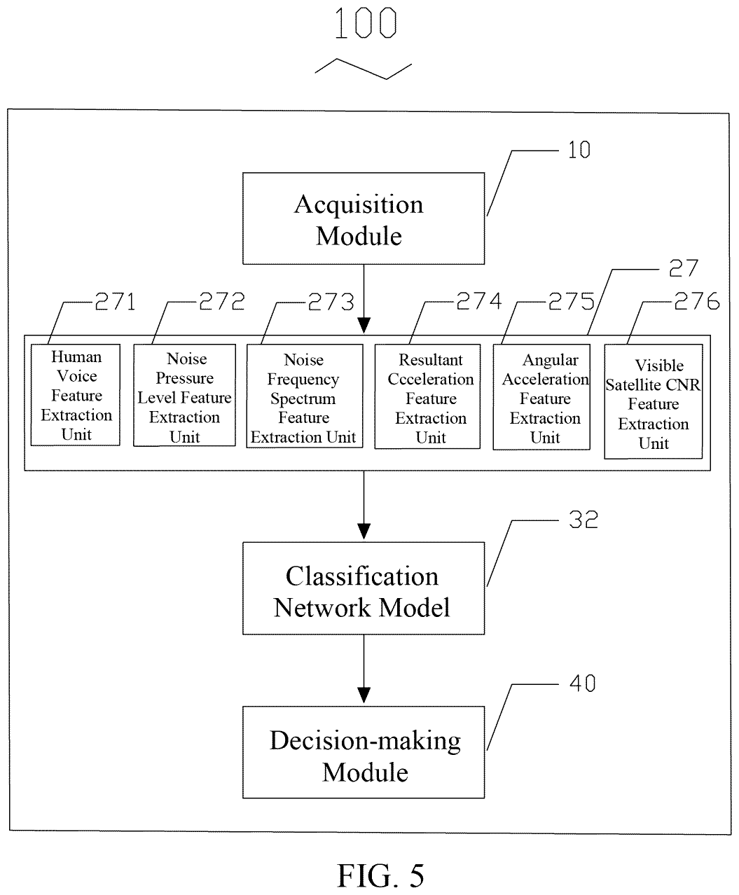

Referring to FIG. 5, when the data processing module 20 is the feature extraction unit 27, the feature extraction unit 27 may include a human voice feature extraction subunit 271, a noise sound pressure level feature extraction subunit 272, a noise spectrum feature extraction subunit 273, a synthetic acceleration feature extraction subunit 274, an angular acceleration feature extraction subunit 275, and a carrier to noise ratio extraction subunit 276 of the visible satellite. In this embodiment, the acquisition module 10 acquires environment data and transmits the environment data to the feature extraction unit 27, the feature extraction unit 27 calls a corresponding feature extraction subunit according to the environment data, so that the feature extraction subunit performs feature extraction on the environment data and transmits a feature extraction result to the classification network model 32. The classification network model 32 recognizes and outputs the environment scene based on the feature extraction result, and the decision-making module 40 call the preset configuration strategy according to the environment scene to automatically adjust sound effect parameters and volume of the smart device.

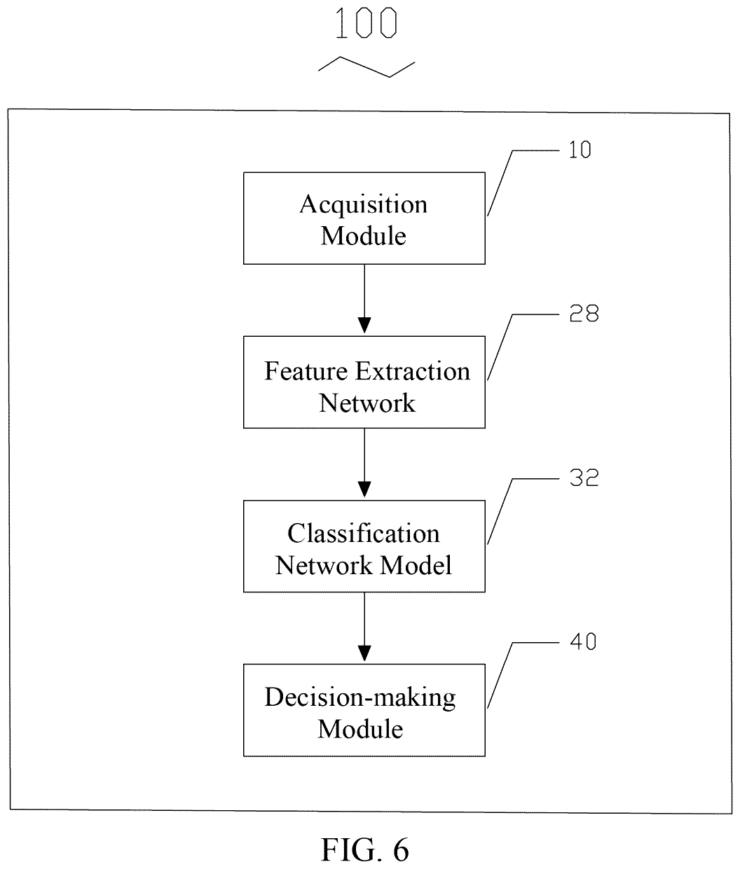

Referring to FIG. 6, when the data processing module 20 is the feature extraction network 28, the feature extraction network 28 may be a neural network capable of automatically learning feature representation, such as a convolutional neural network. In this embodiment, the acquisition module 10 acquires environment data and transmits the environment data to the feature extraction network 28, the feature extraction network 28 automatically learns feature representation according to the environment data and transmits the feature representation to the classification network model 32. The classification network model 32 recognizes and outputs an environment scene based on the feature extraction result, and the decision-making module 40 call a preset configuration strategy according to the environment scene to automatically adjust sound effect parameters and volume of the smart device.

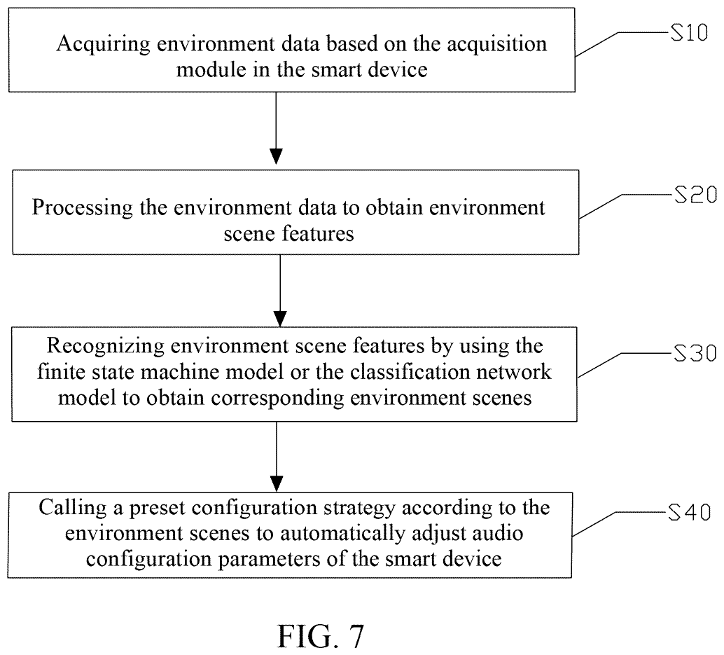

FIG. 7 is a schematic flowchart of an environment scene recognition and decision-making method based on a smart device according to an embodiment of the present disclosure. It should be noted that if the results are substantially the same, the method of the present disclosure is not limited to the sequence shown in FIG. 7. As shown in FIG. 7, the method includes the following steps:

Step S10: acquiring environment data based on the acquisition module in the smart device.

In step S10, the acquisition module may include one or more of an accelerometer, a gyroscope, a magnetometer, a GPS/GNSS receiver, a light sensor, a proximity sensor, and a microphone. The environment data corresponds to the type of the acquisition module, for example, the environment data acquired by the microphone is the audio signal.

Step S20: processing the environment data to obtain environment scene features.

In step S20, the environment data is processed by using the data processing module to obtain environment scene features. In an embodiment, the data processing module includes: one or more of a human voice detection unit, a quiet/noisy detection unit, a long-term noise detection unit, an outdoor/indoor detection unit, a traffic mode detection unit, and a motion/static detection unit, the environment scene features are environment scene types corresponding to the output of each detection unit. In another embodiment, the data processing module includes a feature extraction unit or a feature extraction network, and the environment scene features are used to recognize environment scene types, for example, one or more of a human voice feature, a noise sound pressure level feature, a noise spectrum feature, a synthetic acceleration feature, an angular acceleration feature, and a carrier to noise ratio of a visible satellite.

Step S30: recognizing environment scene features by using the finite state machine model or the classification network model to obtain corresponding environment scenes.

In step S30, the finite state machine model may solve the problem of transition between the correlated finite states. The classification network model may be one or a combination of a feedforward neural network, a convolutional neural network, or a recurrent neural network, or the classification network may be another machine learning algorithm. The environment scenes include a quiet indoor scene, a quiet outdoor scene, a long-term continuous noise scene, a quiet indoor human speaking scene, an outdoor sports scene, a public transportation vehicle scene, a noisy outdoor scene, and a noisy indoor scene.

Step S40: calling a preset configuration strategy according to the environment scene to automatically adjust audio configuration parameters of the smart device.

In step S40, the audio configuration parameters include volume and/or sound effects. In an embodiment, the configuration strategy includes a first audio configuration strategy corresponding to the quiet indoor scene, a second audio configuration strategy corresponding to the quiet outdoor scene, a third audio configuration strategy corresponding to the long-time continuous noise scene, a fourth audio configuration strategy corresponding to the quiet indoor human speaking scene, a fifth audio configuration strategy corresponding to the outdoor sports scene, a sixth audio configuration strategy corresponding to the public transportation vehicle scene, a seventh audio configuration strategy corresponding to the noisy outdoor scene, and an eighth audio configuration strategy corresponding to the noisy indoor scene;

The first audio configuration strategy is medium media playing volume and balanced timbre.

The second audio configuration strategy is medium media playing volume and increased low frequency sound effect.

The third audio configuration strategy is increased media playing volume, reduced low frequency and increased medium-high frequency sound effect.

The fourth audio configuration strategy is reduced media playing volume.

The fifth audio configuration strategy is increased low frequency Bluetooth playing.

The sixth audio configuration strategy is reduced media playing volume.

The seventh audio configuration strategy is increased media playing volume and

reduced low frequency sound effect.

The eighth audio configuration strategy is increased media playing volume and reduced low frequency sound effect.

According to the environment scene recognition and decision-making method based on the smart device, different environment scenes are recognized, and audio configuration parameters of the corresponding intelligent device are adapted to the different environment scenes, which may effectively improve the user experience.

The description is merely an implementation of the present disclosure, and is not intended to limit the patent scope of the present disclosure, and any equivalent structure or equivalent process transformation made by using the specification and accompanying drawings of the present disclosure, or other directly or indirectly applications related technical fields, which are included in the patent protection scope of the present disclosure.

What is claimed is:

1. An environment scene recognition and decision-making system based on a smart device, comprising:
an acquisition module disposed in the smart device and configured to acquire environment data;
a data processing module connected to the acquisition module and configured to process the environment data to obtain environment scene features;
an environment scene recognition module connected to the data processing module and configured to recognize the environment scene features to obtain corresponding environment scenes; and
a decision-making module connected to the environment scene recognition module and configured to call a preset configuration strategy according to the environment scene to automatically adjust audio configuration parameters of the smart device.

2. The environment scene recognition and decision-making system as described in claim 1, wherein the environment scene recognition module comprises a finite state machine model or a classification network model.

3. The environment scene recognition and decision-making system as described in claim 2, wherein when the environment scene recognition module is the finite state machine model, the data processing module comprises: one or more of a human voice detection unit, a quiet/noisy detection unit, a long-term noise detection unit, an outdoor/indoor detection unit, a traffic mode detection unit, and a motion/static detection unit, and the environment scene features are environment scene types corresponding to the output of each detection unit.

4. The environment scene recognition and decision-making system as described in claim 2, wherein when the environment scene recognition module is the classification network model, the data processing module comprises: a feature extraction unit or a feature extraction network, and the environment scene features are features configured to recognize the environment scene types.

5. The environment scene recognition and decision-making system as described in claim 4, wherein the environment scene feature comprises one or more of a human voice feature, a noise pressure level, a noise frequency spectrum feature, a resultant acceleration feature, an angular acceleration feature, and a carrier to noise ratio (CNR) of a visible satellite.

6. The environment scene recognition and decision-making system as described in claim 1, wherein the acquisition module comprises one or more of an accelerometer, a gyroscope, a magnetometer, a global positioning system (GPS)/global navigation satellite system (GNSS) receiver, a light sensor, a proximity sensor, and a microphone.

7. The environment scene recognition and decision-making system as described in claim 1, wherein the environment scene comprises a quiet indoor scene, a quiet outdoor scene, a long-term continuous noise scene, a quiet indoor human speaking scene, an outdoor sports scene, a public transportation vehicle scene, a noisy outdoor scene, and a noisy indoor scene.

8. The environment scene recognition and decision-making system as described in claim 7, wherein the configuration strategy comprises a first audio configuration strategy corresponding to the quiet indoor scene, a second audio configuration strategy corresponding to the quiet outdoor scene, a third audio configuration strategy corresponding to the long-time continuous noise scene, a fourth audio configuration strategy corresponding to the quiet indoor human speaking scene, a fifth audio configuration strategy corresponding to the outdoor sports scene, a sixth audio configuration strategy corresponding to the public transportation vehicle scene, a seventh audio configuration strategy corresponding to the noisy outdoor scene, and an eighth audio configuration strategy corresponding to the noisy indoor scene;
the first audio configuration strategy is medium media playing volume and balanced timbre;
the second audio configuration strategy is medium media playing volume and increased low frequency sound effect;
the third audio configuration strategy is increased media playing volume, reduced low frequency and increased medium-high frequency sound effect;
the fourth audio configuration strategy is reduced media playing volume;
the fifth audio configuration strategy is increased low frequency Bluetooth playing;
the sixth audio configuration strategy is reduced media playing volume;
the seventh audio configuration strategy is increased media playing volume and reduced low frequency sound effect; and
the eighth audio configuration strategy is increased media playing volume and reduced low frequency sound effect.

9. The environment scene recognition and decision-making system as described in claim 1, wherein the audio configuration parameters comprise volume and/or sound effect.

10. An environment scene recognition and decision-making method based on a smart device applied to the environment scene recognition and decision-making system according to claim 1, wherein the environment scene recognition and decision-making method comprises:
acquiring environment data based on an acquisition module in the smart device;
processing the environment data to obtain environment scene features;
recognizing the environment scene features by using a finite state machine model or a classification network model to obtain corresponding environment scenes; and
calling a preset configuration strategy according to the environment scenes to automatically adjust audio configuration parameters of the smart device.
